(19) United States
(12) Patent Application Publication
(10) Pub. No.: US 2026/0132758 A1
(43) Pub. Date: May 14, 2026

(54) Method for boosting a turbofan engine

(71) Applicant: Andrei Kholostenko, Oakland, CA (US)

(72) Inventors: Andrei Kholostenko, Oakland, CA (US); Vladislav MATAFONOV, Oakland, CA (US)

(21) Appl. No.: 19/489,952

(22) PCT Filed: Jul. 26, 2024
(86) PCT No.: PCT/RU2024/000245

§ 371 Date: Dec. 4, 2025

(30) Foreign Application Priority Data
May 28, 2023 (RU) 2023113888

(51) Int. Cl. F02K 3/06

(52) U.S. Cl. CPC F02K 3/06

(57) ABSTRACT

The invention relates to turbofan engines. A method for boosting a turbofan engine consists in increasing the volume of air fed by a fan of the engine into both the core and the bypass duct by briefly activating a brushless electric starter, thereby increasing the rotor speed of the turbofan engine by 5-10% for 10-30 seconds, with a simultaneous proportional increase in the amount of fuel fed into the combustion chamber of the engine. The method makes it possible to briefly increase thrust performance during the takeoff of an aircraft or during an aerial manoeuvre, without increasing the specific weight of the turbofan engine.

The invention relates to booster systems for turbofan engines.

Various methods for boosting turbofan engines based on the injection of water into the flow duct are widely known (patents RU 2284418C1 , RU 2005109449 A, RU 2523510C1 ). These methods involve installing water injection systems into the combustion chamber, compressor, and upstream of the compressor. In some of the solutions, a flammable liquid is added to the water.

The obvious drawback of these solutions is the need to carry a supply of liquid onboard an aircraft to ensure engine operation in the booster mode and a system for delivering this liquid to the turbofan engine's working duct.

A method for feeding gas into the combustion chamber of a turbofan engine is well known (patent RU 2562822C2 ). A gas generator is installed outside the engine body, with oxidizer and fuel lines connected to its inlet, and a gas duct connected to the main engine's air duct to its outlet.

The disadvantage of the given solution is that it is only suitable for use at high flight altitudes, and the comparative complexity of its technical implementation.

A known method for boosting a turbofan engine (patent RU 2523510C1 ) is considered to be the closest analogue based on a number of features. This method involves feeding the combustion chamber or compressor with such an amount of fuel that is only sufficient for its complete combustion. Additional fuel is also fed into the combustion chamber in the amount necessary to decrease the gas temperature in the combustion chamber to a safe level (atmospheric boost function). When engine's atmospheric boost function is activated, an igniter of any type is simultaneously activated at the turbine outlet.

The disadvantage of this method is that combustion products during boosting contain large amounts of toxic gases such as carbon monoxide, nitrogen oxides, unburned hydrocarbons, and soot. The second disadvantage is a significant, up to several times, increase in the volume of fuel being burned.

The purpose of this invention is to develop a method for a short-term increase in the power of a turbofan engine for a duration of up to 30 seconds without deterioration in the specific power of the engine and without the need to make significant changes to the engine design.

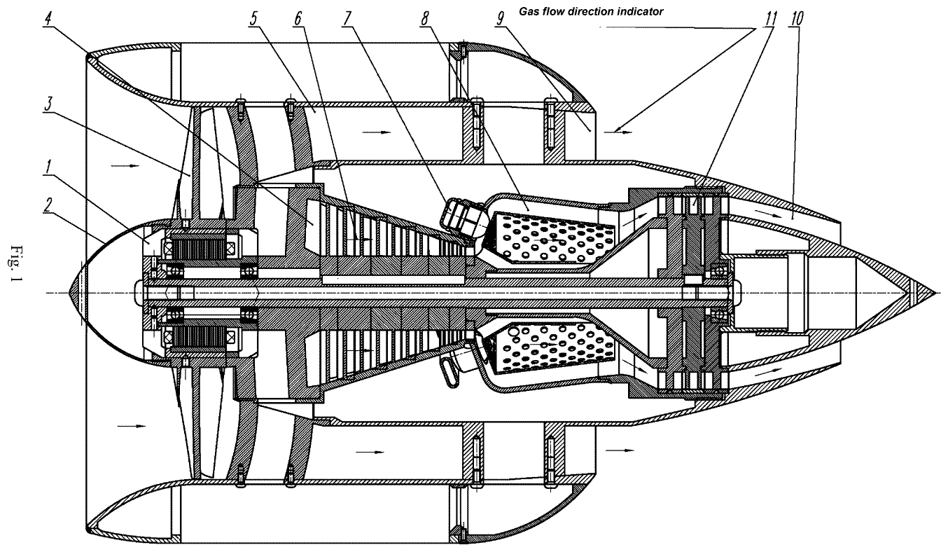

The stated goal is achieved by equipping the turbofan engine with a starter with increased power compared to that required to start the engine by 40%-60% with maximum operating speed, allowing the operating speed of the turbofan engine to be increased by 10%. This technical feasibility is achieved by using a brushless DC motor with a high-energy magnet rotor as a starter, coupled with a starter speed controller based on low-resistance power field-effect transistors (of MOSFET or HEXFET type). When the starter is briefly engaged for no more than 30 seconds, no additional cooling measures are required. Increasing the brushless motor's power in this scenario does not require a significant increase in its dimensions or weight, by 30% at the most. The mass of a brushless starter does not exceed 2% of the structural weight of a turbofan engine. Increasing the rotor speed increases the amount of air supplied to the combustion chamber, while the volume of fuel supplied to the combustion chamber increases proportionally due to the increased pressure drop across the fuel nozzles, resulting in an increased volume of combustion products. The excess volume of combustion products supplied to the engine core nozzle cluster, as well as the increased airflow passing through the bypass duct nozzle, both result in an increased thrust of the turbofan engine. An increase in the thermal power of the engine in the booster mode will lead to an increase in temperature in the combustion chamber, in the turbine cluster, and in the nozzle cluster of the engine core; this limits the operating time of the engine in the booster mode. The approximate duration of boosting is determined for a low-power turbofan engine, a typical section of which is shown in FIG. 1. For this design, the boosting time should not exceed 30 seconds.

The invention is illustrated by a drawing. FIG. 1 shows an axial section of a low-power turbofan engine equipped with a starter based on a brushless DC electric motor. The starter (pos. 1) is connected to the rotor using a gearless design. The starter is located under the fairing cap (pos. 2) of the fan (pos. 3), which forces air into both ducts. The bypass duct is marked as pos. 5, whereas the engine core is marked as pos. 4. Multistage axial compressor—pos. 6. Fuel manifold with nozzles—pos. 7. Annular combustion chamber—pos. 8. Bypass duct nozzle cluster—pos. 9. Engine core nozzle cluster—pos. 10. Turbine cluster—pos. 11.

The technical solution of the invention allows for a short-term, approximately 30-second increase in thrust of a turbofan engine by up to 10% of its maximum operating thrust, while maintaining the engine's overall design, and with only a slight increase in the engine's specific weight.

1. A method for boosting a turbofan engine consisting in increasing the volume of air fed by a fan into both the core and the bypass duct by briefly activating an electric starter, with a brushless electric motor being used as a starter, thereby increasing the rotor speed of the turbofan engine by 5-10% for 10-30 seconds, with a simultaneous proportional increase in the amount of fuel fed into the combustion chamber of the engine.
